(19) United States
(12) Patent Application Publication
(10) Pub. No.: US 2025/0097825 A1
(43) Pub. Date: Mar. 20, 2025

(54) METHOD FOR SHARING UE-SPECIFIC INFORMATION BETWEEN NEAR-REAL-TIME RADIO ACCESS NETWORK INTELLIGENT CONTROLLERS

(71) Applicant: NOKIA SOLUTIONS AND NETWORKS OY, Espoo (FI)

(72) Inventors: Subramanya CHANDRASHEKAR, Bangalore (IN); Ömer BULAKCI, Munich (DE); Alistair URIE, Massy (FR)

(21) Appl. No.: 18/720,629

(22) PCT Filed: Dec. 15, 2022
(86) PCT No.: PCT/EP2022/086098

§ 371 Date: Jun. 15, 2024

(30) Foreign Application Priority Data
Dec. 15, 2021 (IN) 202141058410

(51) Int. Cl. H04W 48/08; H04W 8/24; H04W 92/12; H04W 92/20

(52) U.S. Cl. CPC H04W 48/08; H04W 8/24; H04W 92/12; H04W 92/20

(57) ABSTRACT

An apparatus comprising means for implementing a near-real-time radio access network intelligent controller; means for storing user equipment-specific information relating to at least one user equipment connected to a first access node being controlled by said near-real-time radio access network intelligent controller; means for establishing an interface to a second near-real-time radio access network intelligent controller; and means for transferring at least said user equipment-specific information to said second near-real-time radio access network intelligent controller in response to said user equipment establishing a connection to a second access node being controlled by said second near-real-time radio access network intelligent controller.

### TECHNICAL FIELD

The present invention relates to sharing at least user equipment-specific information among network entities.

### BACKGROUND

5G specifications provide an option to split the internal structure of an access node gNodeB (gNB) into entities called CU (Central Unit) and one or more DUs (Distributed Unit), which are connected by a F1 interface, as specified in 3GU.S. Plant Pat. No. 38,473. The split may provide traffic aggregation in terms of one gNB CU (or gNB-CU) serving a plurality of gNB DUs (or gNB-DU) operating as the actual node points for the air interface. There may also be a RAN (Radio Access Network) intelligent controller (RIC) connected through an E2 interface to the nodes gNB-DU and gNB-CU. RIC is a logical function that, according to O-RAN (Open Radio Access Network) architecture (as defined by the O-RAN alliance), may be further divided into functions of a non-real-time (non-RT) RIC and a near-real-time (near-RT) RIC with the non-RT RIC sending declarative policies to one or more near-RT RIC over the A1 interface. The near-real-time RIC enables near-real-time control and optimization of RAN elements and resources via fine-grained data collection and actions over E2 interface.

The near-RT-RIC functionality includes, among other things, optimization of services and QoS of provided to a user equipment (UE). This is made possible by accumulation of data from large variety of per-UE performance and service parameters

However, when a UE undergoes mobility such that the source and the target RAN nodes are served by different near-RT-RICs, this UE-specific generated information stored in the near-RT RIC is lost. In case of current O-RAN specifications, there is no mechanism to secure the per-UE intelligence information between RICs, e.g., in case of RIC change and geographically distributed RICs.

The near-RT RIC functionality includes, among other things, optimization of radio access mechanisms on a per cell basis using information collected from each cell served by a given gNB and from cells served by neighbouring gNB connected to the same near-RT RIC. In case of current O-RAN specifications, there is no mechanism defined to also use information from cell served by a gNB connected to neighbouring near-RT RIC.

### SUMMARY

Now, an improved method and technical equipment implementing the method has been invented, by which the above problems are alleviated. Various aspects include a method, an apparatus and a non-transitory computer readable medium comprising a computer program, or a signal stored therein, which are characterized by what is stated in the independent claims. Various details of the embodiments are disclosed in the dependent claims and in the corresponding images and description.

The scope of protection sought for various embodiments of the invention is set out by the independent claims. The embodiments and features, if any, described in this specification that do not fall under the scope of the independent claims are to be interpreted as examples useful for understanding various embodiments of the invention.

According to a first aspect, there is provided an apparatus comprising means for implementing a near-real-time radio access network intelligent controller; means for storing user equipment-specific information relating to at least one user equipment connected to a first access node being controlled by said near-real-time radio access network intelligent controller; means for establishing an interface to a second near-real-time radio access network intelligent controller; and means for transferring at least said user equipment-specific information to said second near-real-time radio access network intelligent controller in response to said user equipment establishing a connection to a second access node being controlled by said second near-real-time radio access network intelligent controller.

According to an embodiment, the interface is a logical association implemented on one or more existing interfaces between the near-real-time radio access network intelligent controllers.

According to an embodiment, said existing interfaces comprise an E2 interface between a near-real-time radio access network intelligent controller and a corresponding access node and a X2/Xn interface between said access nodes.

According to an embodiment, the interface is implemented as direct message exchange between the near-real-time radio access network intelligent controllers.

According to an embodiment, said existing interfaces comprise a service-based architecture message bus.

According to an embodiment, the apparatus comprises means for triggering the transfer of at least said user equipment-specific information in response to detecting an event relating to a handover or dual connectivity of said at least one user equipment.

According to an embodiment, an indication about detecting the event relating to the handover or dual connectivity of said at least one user equipment is received from the second near-real-time radio access network intelligent controller.

According to an embodiment, the apparatus comprises means for transferring access node-specific information about said first access node to said second near-real-time radio access network intelligent controller.

According to an embodiment, the apparatus comprises means for transferring user equipment-specific policy information obtained from a corresponding non-real-time radio access network intelligent controller to said second near-real-time radio access network intelligent controller.

According to an embodiment, said at least one user equipment is identified by a unique identifier, such as a pair of AMF UE NGAP ID identifier and GUAMI (Globally Unique AMI) identifier.

According to an embodiment, the apparatus comprises means for transferring information concerning a list of connected access nodes, such as e/gNBs, and served cells over said interface to the second near-real-time radio access network intelligent controller.

According to an embodiment, the apparatus comprises means for transferring information concerning the connected access nodes, such as e/gNBs, and served cells over said interface to the second near-real-time radio access network intelligent controller.

According to an embodiment, the apparatus comprises means for transferring information derived by the apparatus using information obtained from connected access nodes, such as e/gNBs, over said interface to the second near-real-time radio access network intelligent controller.

An apparatus according to a second aspect comprises at least one processor and at least one memory, said at least one memory stored with computer program code thereon, the at least one memory and the computer program code configured to, with the at least one processor, cause the apparatus to implement functionalities of a near-real-time radio access network intelligent controller and at least to perform: store user equipment-specific information relating to at least one user equipment connected to a first access node being controlled by said near-real-time radio access network intelligent controller; establish an interface to a second near-real-time radio access network intelligent controller; and transfer at least said user equipment-specific information to said second near-real-time radio access network intelligent controller in response to said user equipment establishing a connection to a second access node being controlled by said second near-real-time radio access network intelligent controller.

A method according to a third aspect comprises storing, by an apparatus comprising functionalities of a near-real-time radio access network intelligent controller, user equipment-specific information relating to at least one user equipment connected to a first access node being controlled by said near-real-time radio access network intelligent controller; establishing an interface to a second near-real-time radio access network intelligent controller; and transferring at least said user equipment-specific information to said second near-real-time radio access network intelligent controller in response to said user equipment establishing a connection to a second access node being controlled by said second near-real-time radio access network intelligent controller.

Computer readable storage media according to further aspects comprise code for use by an apparatus, which when executed by a processor, causes the apparatus to perform the above methods.

### BRIEF DESCRIPTION OF THE DRAWINGS

For a more complete understanding of the example embodiments, reference is now made to the following descriptions taken in connection with the accompanying drawings in which:

FIG. 1 shows a schematic block diagram of an apparatus for incorporating functionalities for implementing various embodiments;

FIG. 2 shows schematically a layout of an apparatus according to an example embodiment;

FIG. 3 shows a part of an exemplifying radio access network;

FIG. 4 illustrates overview on the 5G deployment model for the split gNB;

FIG. 5 shows an example of various interfaces among a variety of network elements described in O-RAN architecture

FIG. 6 shows an example of ORAN Near-RT RIC architecture;

FIG. 7 shows an example of a service-based (SB) architecture (SBA);

FIG. 8 shows an exemplified flow chart of a method according to an embodiment;

FIGS. 9 to 11 show examples according to some embodiments; and

FIGS. 12 to 13 show exemplified signalling charts according to some embodiments.

### DETAILED DESCRIPTON OF SOME EXAMPLE EMBODIMENTS

The following describes in further detail suitable apparatus and possible mechanisms carrying out the operations sharing for the user equipment-specific information among near-RT RICs. While the following focuses on 5G networks, the embodiments as described further below are by no means limited to be implemented in said networks only, but they are applicable in any network and protocol entities supporting the user equipment-specific information sharing among near-RT RICs or equivalent entities.

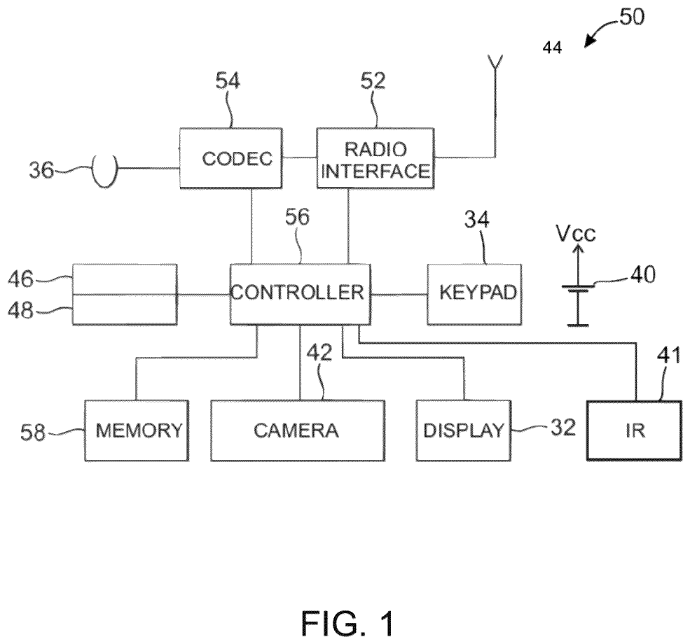

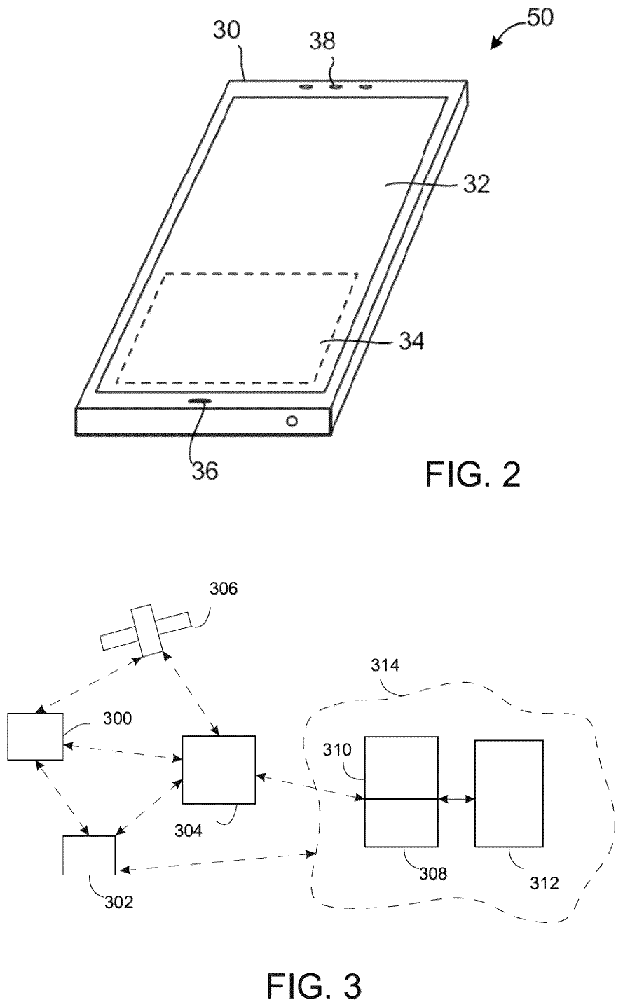

In this regard, reference is first made to FIGS. 1 and 2, where FIG. 1 shows a schematic block diagram of an exemplary apparatus or electronic device 50, which may incorporate the arrangement according to the embodiments. FIG. 2 shows a layout of an apparatus according to an example embodiment. The elements of FIGS. 1 and 2 will be explained next.

The electronic device 50 may for example be a user device, a mobile terminal or user equipment of a wireless communication system. The apparatus 50 may comprise a housing 30 for incorporating and protecting the device. The apparatus 50 further may comprise a display 32 and a keypad 34. Instead of the keypad, the user interface may be implemented as a virtual keyboard or data entry system as part of a touch-sensitive display.

The apparatus may comprise a microphone 36 or any suitable audio input which may be a digital or analogue signal input. The apparatus 50 may further comprise an audio output device, such as anyone of: an earpiece 38, speaker, or an analogue audio or digital audio output connection. The apparatus 50 may also comprise a battery 40 (or the device may be powered by any suitable mobile energy device such as solar cell, fuel cell or clockwork generator). The apparatus may further comprise a camera 42 capable of recording or capturing images and/or video. The apparatus 50 may further comprise an infrared port 41 for short range line of sight communication to other devices. In other embodiments the apparatus 50 may further comprise any suitable short-range communication solution such as for example a Bluetooth wireless connection or a USB/firewire wired connection.

The apparatus 50 may comprise a controller 56 or processor for controlling the apparatus 50. The controller 56 may be connected to memory 58 which may store both user data and instructions for implementation on the controller 56. The memory may be random access memory (RAM) and/or read only memory (ROM). The memory may store computer-readable, computer-executable software including instructions that, when executed, cause the controller/processor to perform various functions described herein. In some cases, the software may not be directly executable by the processor but may cause a computer (e.g., when compiled and executed) to perform functions described herein. The controller 56 may further be connected to codec circuitry 54 suitable for carrying out coding and decoding of audio and/or video data or assisting in coding and decoding carried out by the controller.

The apparatus 50 may comprise radio interface circuitry 52 connected to the controller and suitable for generating wireless communication signals for example for communication with a cellular communications network, a wireless communications system or a wireless local area network. The apparatus 50 may further comprise an antenna 44 connected to the radio interface circuitry 52 for transmitting radio frequency signals generated at the radio interface circuitry 52 to other apparatus(es) and for receiving radio frequency signals from other apparatus(es).

In the following, different exemplifying embodiments will be described using, as an example of an access architecture to which the embodiments may be applied, a radio access architecture based on Long Term Evolution Advanced (LTE Advanced, LTE-A) or new radio (NR, 5G), or beyond 5G, e.g., 6G, without restricting the embodiments to such an architecture, however. A person skilled in the art appreciates that the embodiments may also be applied to other kinds of communications networks having suitable means by adjusting parameters and procedures appropriately. Some examples of other options for suitable systems are the universal mobile telecommunications system (UMTS) radio access network (UTRAN or E-UTRAN), long term evolution (LTE, the same as E-UTRA), wireless local area network (WLAN or WiFi), worldwide interoperability for microwave access (WiMAX), Bluetooth®, personal communications services (PCS), ZigBee®, wideband code division multiple access (WCDMA), systems using ultra-wideband (UWB) technology, sensor networks, mobile ad-hoc networks (MANETs) and Internet protocol multimedia subsystems (IMS) or any combination thereof.

FIG. 3 depicts examples of simplified system architectures only showing some elements and functional entities, all being logical units, whose implementation may differ from what is shown. The connections shown in FIG. 3 are logical connections; the actual physical connections may be different. It is apparent to a person skilled in the art that the system typically comprises also other functions and structures than those shown in FIG. 3. The embodiments are not, however, restricted to the system given as an example but a person skilled in the art may apply the solution to other communication systems provided with necessary properties.

The example of FIG. 3 shows a part of an exemplifying radio access network.

FIG. 3 shows user devices 300 and 302 configured to be in a wireless connection on one or more communication channels in a cell with an access node (such as (e/g)NodeB or a base transceiver station (BTS)) 304 providing the cell. The physical link from a user device to a (e/g)NodeB is called uplink or reverse link and the physical link from the (e/g)NodeB to the user device is called downlink or forward link. It should be appreciated that (e/g)NodeBs or their functionalities may be implemented by using any node (such as Integrated Access and Backhaul (IAB) node), host, server or access point etc. entity suitable for such a usage.

A communication system typically comprises more than one (e/g)NodeB in which case the (e/g)NodeBs may also be configured to communicate with one another over links, wired or wireless, designed for the purpose. These links may be used for signaling purposes. The (e/g)NodeB is or comprises a computing device configured to control the radio resources of communication system it is coupled to. The NodeB may also be referred to as a base station, an access point, an access node or any other type of interfacing device including a relay station capable of operating in a wireless environment. The (e/g)NodeB includes or is coupled to transceivers. From the transceivers of the (e/g)NodeB, a connection is provided to an antenna unit that establishes bi-directional radio links to user devices. The antenna unit may comprise a plurality of antennas or antenna elements. The (e/g)NodeB is further connected to core network 310 (CN or next generation core NGC). Depending on the system, the counterpart on the CN side can be a serving gateway (S-GW, routing and forwarding user data packets), packet data network gateway (P-GW), for providing connectivity of user devices (UEs) to external packet data networks, or mobile management entity (MME), etc. The CN may comprise network entities or nodes that may be referred to management entities. Examples of the network entities comprise at least an Access and Mobility Management Function (AMF).

In 5G NR, the User Plane Function (UPF) may be used to separate the control plane and the user plane functions. Therein, the Packet Gateway (PGW) control and user plane functions may be decoupled, whereby the data forwarding component (PGW-U) may be decentralized, while the PGW-related signaling (PGW-C) may remain in the core. This allows packet processing and traffic aggregation to be performed closer to the network edge, increasing bandwidth efficiencies while reducing network.

The user device (also called a user equipment (UE), a user terminal, a terminal device, a wireless device, a mobile station (MS) etc.) illustrates one type of an apparatus to which resources on the air interface are allocated and assigned, and thus any feature described herein with a user device may be implemented with a corresponding network apparatus, such as a relay node, an eNB, and an gNB. An example of such a relay node is a layer 3 relay (self-backhauling relay) towards the base station.

The user device typically refers to a portable computing device that includes wireless mobile communication devices operating with or without a subscriber identification module (SIM), including, but not limited to, the following types of devices: a mobile station (mobile phone), smartphone, personal digital assistant (PDA), handset, device using a wireless modem (alarm or measurement device, etc.), laptop and/or touch screen computer, tablet, game console, notebook, and multimedia device. It should be appreciated that a user device may also be a nearly exclusive uplink only device, of which an example is a camera or video camera loading images or video clips to a network. A user device may also be a device having capability to operate in Internet of Things (IoT) network which is a scenario in which objects are provided with the ability to transfer data over a network without requiring human-to-human or human-to-computer interaction. Accordingly, the user device may be an IoT-device. The user device may also utilize cloud. In some applications, a user device may comprise a small portable device with radio parts (such as a watch, earphones or eyeglasses) and the computation is carried out in the cloud. The user device (or in some embodiments a layer 3 relay node) is configured to perform one or more of user equipment functionalities. The user device may also be called a subscriber unit, mobile station, remote terminal, access terminal, user terminal or user equipment (UE) just to mention but a few names or apparatuses.

Various techniques described herein may also be applied to a cyber-physical system (CPS) (a system of collaborating computational elements controlling physical entities). CPS may enable the implementation and exploitation of massive amounts of interconnected ICT devices (sensors, actuators, processors microcontrollers, etc.) embedded in physical objects at different locations. Mobile cyber physical systems, in which the physical system in question has inherent mobility, are a subcategory of cyber-physical systems. Examples of mobile physical systems include mobile robotics and electronics transported by humans or animals.

Additionally, although the apparatuses have been depicted as single entities, different units, processors and/or memory units (not all shown in FIG. 1) may be implemented.

5G enables using multiple input-multiple output (MIMO) antennas, many more base stations or nodes than the LTE (a so-called small cell concept), including macro sites operating in co-operation with smaller stations and employing a variety of radio technologies depending on service needs, use cases and/or spectrum available. The access nodes of the radio network form transmission/reception (TX/Rx) points (TRPs), and the UEs are expected to access networks of at least partly overlapping multi-TRPs, such as macro-cells, small cells, pico-cells, femto-cells, remote radio heads, relay nodes, etc. The access nodes may be provided with Massive MIMO antennas, i.e. very large antenna array consisting of e.g. hundreds of antenna elements, implemented in a single antenna panel or in a plurality of antenna panels, capable of using a plurality of simultaneous radio beams for communication with the UE. The UEs may be provided with MIMO antennas having an antenna array consisting of e.g. dozens of antenna elements, implemented in a single antenna panel or in a plurality of antenna panels. Thus, the UE may access one TRP using one beam, one TRP using a plurality of beams, a plurality of TRPs using one (common) beam or a plurality of TRPs using a plurality of beams.

The 4G/LTE networks support some multi-TRP schemes, but in 5G NR the multi-TRP features are enhanced e.g. via transmission of multiple control signals via multi-TRPs, which enables to improve link diversity gain. Moreover, high carrier frequencies (e.g., mmWaves) together with the Massive MIMO antennas require new beam management procedures for multi-TRP technology.

5G mobile communications supports a wide range of use cases and related applications including video streaming, augmented reality, different ways of data sharing and various forms of machine type applications (such as (massive) machine-type communications (mMTC), including vehicular safety, different sensors and real-time control. 5G is expected to have multiple radio interfaces, namely below 6 GHz, cmWave and mmWave, and also capable of being integrated with existing legacy radio access technologies, such as the LTE. Integration with the LTE may be implemented, at least in the early phase, as a system, where macro coverage is provided by the LTE and 5G radio interface access comes from small cells by aggregation to the LTE. In other words, 5G is planned to support both inter-RAT (Radio Access Technology) operability (such as LTE-5G) and inter-RI operability (inter-radio interface operability, such as below 6GHz-cmWave, below 6 GHz-cmWave-mmWave). One of the concepts considered to be used in 5G networks is network slicing in which multiple independent and dedicated virtual sub-networks (network instances) may be created within the same infrastructure to run services that have different requirements on latency, reliability, throughput and mobility.

Frequency bands for 5G NR are separated into two frequency ranges: Frequency Range 1 (FR1) including sub-6 GHz frequency bands, i.e. bands traditionally used by previous standards, but also new bands extended to cover potential new spectrum offerings from 410 MHz to 7125 MHz, and Frequency Range 2 (FR2) including frequency bands from 24.25 GHz to 52.6 GHz. Thus, FR2 includes the bands in the mmWave range, which due to their shorter range and higher available bandwidth require somewhat different approach in radio resource management compared to bands in the FR1.

The current architecture in LTE networks is fully distributed in the radio and fully centralized in the core network. The low latency applications and services in 5G require to bring the content close to the radio which leads to local break out and multi-access edge computing (MEC). 5G enables analytics and knowledge generation to occur at the source of the data. This approach requires leveraging resources that may not be continuously connected to a network such as laptops, smartphones, tablets and sensors. MEC provides a distributed computing environment for application and service hosting. It also has the ability to store and process content in close proximity to cellular subscribers for faster response time. Edge computing covers a wide range of technologies such as wireless sensor networks, mobile data acquisition, mobile signature analysis, cooperative distributed peer-to-peer ad hoc networking and processing also classifiable as local cloud/fog computing and grid/mesh computing, dew computing, mobile edge computing, cloudlet, distributed data storage and retrieval, autonomic self-healing networks, remote cloud services, augmented and virtual reality, data caching, Internet of Things (massive connectivity and/or latency critical), critical communications (autonomous vehicles, traffic safety, real-time analytics, time-critical control, healthcare applications).

The communication system is also able to communicate with other networks, such as a public switched telephone network or the Internet 312, or utilize services provided by them. The communication network may also be able to support the usage of cloud services, for example at least part of core network operations may be carried out as a cloud service (this is depicted in FIG. 3 by “cloud” 314). The communication system may also comprise a central control entity, or a like, providing facilities for networks of different operators to cooperate for example in spectrum sharing.

Edge cloud may be brought into radio access network (RAN) by utilizing network function virtualization (NFV) and software defined networking (SDN). Using edge cloud may mean access node operations to be carried out, at least partly, in a server, host or node operationally coupled to a remote radio head, radio unit (RU) or base station comprising radio parts. It is also possible that node operations will be distributed among a plurality of servers, nodes or hosts. Application of cloudRAN architecture enables RAN real time functions being carried out at the RAN side (e.g. in a distributed unit, DU) and non-real time functions being carried out in a centralized manner (e.g. in a centralized unit, CU 308).

While Cloud RAN and Open RAN (ORAN or O-RAN) may have ties and may often be discussed together, they may also be considered as different technologies and one can be applied without the other. Open RAN defines, for example, open interfaces between network elements, while Cloud RAN may, for example, virtualize the baseband and separate baseband hardware and software. The open radio access network, O-RAN, as defined by the Open RAN Alliance, refers to a concept enabling interoperability of RAN elements between different vendors over a set of defined interfaces. Thus, O-RAN architecture for example enables baseband unit and radio unit components from different vendors to operate together.

It should also be understood that the distribution of labor between core network operations and base station operations may differ from that of the LTE or even be non-existent. Some other technology advancements probably to be used are Big Data and all-IP, which may change the way networks are being constructed and managed. 5G (or new radio, NR) networks are being designed to support multiple hierarchies, where MEC servers can be placed between the core and the base station or nodeB (e/gNB). It should be appreciated that MEC can be applied in 4G networks as well. The gNB is a next generation Node B (or, new Node B) supporting the 5G network (i.e., the NR).

5G may also utilize non-terrestrial nodes 306, e.g. access nodes, to enhance or complement the coverage of 5G service, for example by providing backhauling, wireless access to wireless devices, service continuity for machine-to-machine (M2M) communication, service continuity for Internet of Things (IoT) devices, service continuity for passengers on board of vehicles, ensuring service availability for critical communications and/or ensuring service availability for future railway/maritime/aeronautical communications. The non-terrestrial nodes may have fixed positions with respect to the Earth surface or the non-terrestrial nodes may be mobile non-terrestrial nodes that may move with respect to the Earth surface. The non-terrestrial nodes may comprise satellites and/or HAPSs (High Altitude Platform Stations). Satellite communication may utilize geostationary earth orbit (GEO) satellite systems, but also low earth orbit (LEO) satellite systems, in particular mega-constellations (systems in which hundreds of (nano) satellites are deployed). Each satellite in the mega-constellation may cover several satellite-enabled network entities that create on-ground cells. The on-ground cells may be created through an on-ground relay node 304 or by a gNB located on-ground or in a satellite.

A person skilled in the art appreciates that the depicted system is only an example of a part of a radio access system and in practice, the system may comprise a plurality of (e/g)NodeBs, the user device may have an access to a plurality of radio cells and the system may comprise also other apparatuses, such as physical layer relay nodes or other network elements, etc. At least one of the (e/g)NodeBs or may be a Home(e/g)nodeB. Additionally, in a geographical area of a radio communication system a plurality of different kinds of radio cells as well as a plurality of radio cells may be provided. Radio cells may be macro cells (or umbrella cells) which are large cells, usually having a diameter of up to tens of kilometers, or smaller cells such as micro-, femto- or picocells. The (e/g)NodeBs of FIG. 1 may provide any kind of these cells. A cellular radio system may be implemented as a multilayer network including several kinds of cells. Typically, in multilayer networks, one access node provides one kind of a cell or cells, and thus a plurality of (e/g)NodeBs are required to provide such a network structure.

For fulfilling the need for improving the deployment and performance of communication systems, the concept of “plug-and-play” (e/g)NodeBs has been introduced. Typically, a network which is able to use “plug-and-play” (e/g)Node Bs, includes, in addition to Home (e/g)NodeBs (H(e/g)nodeBs), a home node B gateway, or HNB-GW (not shown in FIG. 1). A HNB Gateway (HNB-GW), which is typically installed within an operator's network may aggregate traffic from a large number of HNBs back to a core network.

The Radio Resource Control (RRC) protocol is used in various wireless communication systems for defining the air interface between the UE and a base station, such as eNB/gNB. This protocol is specified by 3GPP in in TS 36.331 for LTE and in TS 38.331 for 5G. In terms of the RRC, the UE may operate in LTE and in 5G in an idle mode or in a connected mode, wherein the radio resources available for the UE are dependent on the mode where the UE at present resides. In 5G, the UE may also operate in inactive mode. In the RRC idle mode, the UE has no connection for communication, but the UE is able to listen to page messages. In the RRC connected mode, the UE may operate in different states, such as CELL_DCH (Dedicated Channel), CELL_FACH (Forward Access Channel), CELL_PCH (Cell Paging Channel) and URA_PCH (URA Paging Channel). The UE may communicate with the eNB/gNB via various logical channels like Broadcast Control Channel (BCCH), Paging Control Channel (PCCH), Common Control Channel (CCCH), Dedicated Control Channel (DCCH), Dedicated Traffic Channel (DTCH).

The transitions between the states are controlled by a state machine of the RRC. When the UE is powered up, it is in a disconnected mode/idle mode. The UE may transit to RRC connected mode with an initial attach or with a connection establishment. If there is no activity from the UE for a short time, eNB/gNB may suspend its session by moving to RRC Inactive and can resume its session by moving to RRC connected mode. The UE can move to the RRC idle mode from the RRC connected mode or from the RRC inactive mode.

The actual user and control data from network to the UEs is transmitted via downlink physical channels, which in 5G include Physical downlink control channel (PDCCH) which carries the necessary downlink control information (DCI), Physical Downlink Shared Channel (PDSCH), which carries the user data and system information for user, and Physical broadcast channel (PBCH), which carries the necessary system information to enable a UE to access the 5G network.

The user and control data from UE to the network is transmitted via uplink physical channels, which in 5G include Physical Uplink Control Channel (PUCCH), which is used for uplink control information including HARQ (Hybrid Automatic Repeat reQuest) feedback acknowledgments, scheduling request, and downlink channel-state information for link adaptation, Physical Uplink Shared Channel (PUSCH), which is used for uplink data transmission, and Physical Random Access Channel (PRACH), which is used by the UE to request connection setup referred to as random access.

5G specifications provide an option to split the internal structure of a gNB into entities called CU (Central Unit) and one or more DUs (Distributed Unit), which are connected by a F1 interface, as specified in 3GU.S. Plant Pat. No. 38,473. The split may provide traffic aggregation in terms of one gNB CU serving a plurality of gNB DUs operating as the actual node points for the air interface. The gNB-CU may be further split to CU-CP (Control Plane) and CU-UP (User Plane) and E1 interface has been introduced between them. Information of available resources and load must be shared across these network entities to implement various RRM (Radio Resource Management) functionalities.

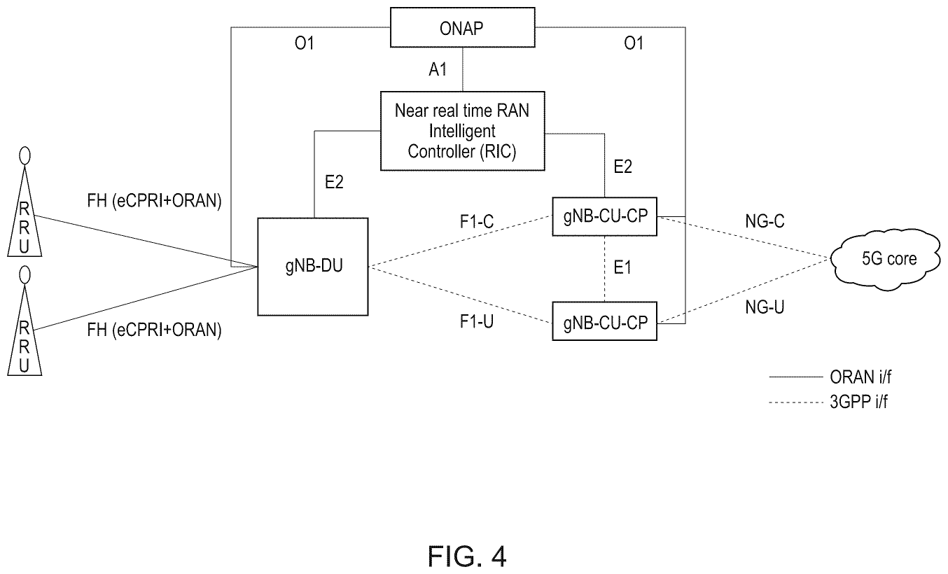

FIG. 4 provides a basic overview on the 5G deployment model for the split gNB. The gNB comprises a Centralized Unit (gNB-CU) and one or more Distributed Units (gNB-DUs) connected to the gNB-CU. gNB-CU is a logical node that includes the gNB functions like user data transfer, Mobility management, Radio access network sharing, Positioning, Session Management etc., except such functions, which are allocated exclusively to the gNB-DU. gNB-CU controls the operation of gNB-DUs over F1 interface.

As discussed above, O-RAN (Open Radio Access Network) provides open standards to complement what 3GPP has already defined in terms of functionalities, with a special focus on Radio Access Network (RAN) programmability and the application of ML/AI techniques. A RAN intelligent controller (RIC) is specified in ORAN WG3 (Working Group 3). The RIC may be divided into functions of a non-real-time (Non-RT) RIC and a near-real-time (Near-RT) RIC.

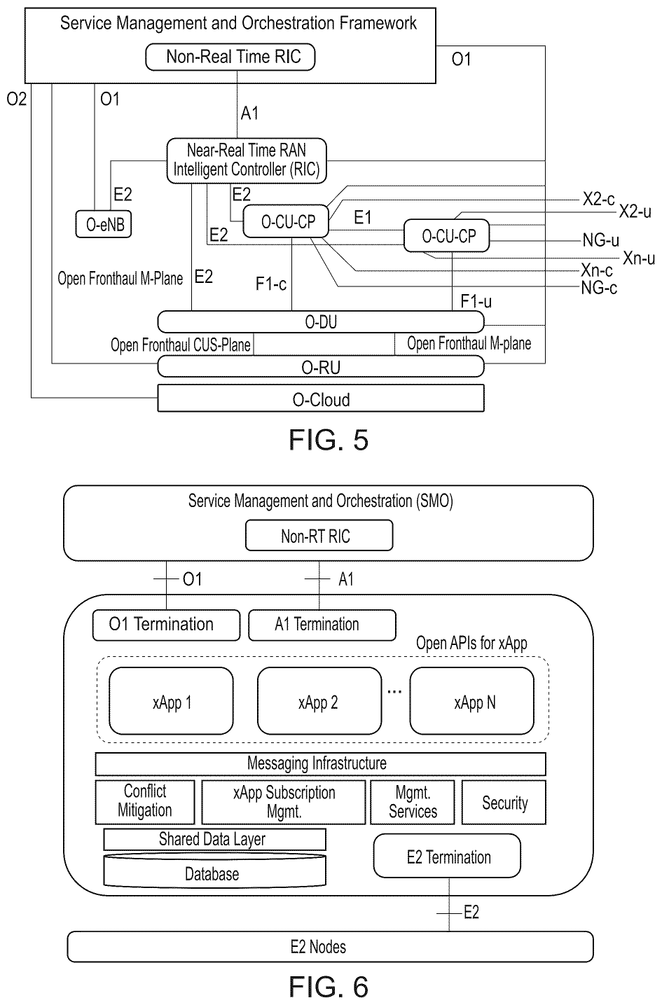

FIG. 5 shows are shown with various interfaces to a variety of network elements. It is noted that in this context of describing the O-RAN architecture the above nodes eNB and the split parts of gNB, i.e. CU-CP, CU-UP and DU are referred to as O-eNB, O-CU-CP, O-CU-UP and O-DU. The Non-RT RIC operates in the Service Management and Orchestration (SMO) domain and uses A1 interface to support intelligent RAN optimization by providing policy-based guidance, i.e., Declarative Policies, ML model management and Enrichment Information to guide the Near-RT RIC. A1 is defined in the document ORAN-WG2.A1.AP: A1 Application Protocol. It connects the Non-RT RIC to Near-RT RIC using a RESTful interface to send Declarative policies to Near-RT RIC. The A1 Policy includes the scope identifier which defines the object/resource to which the policy applies. The scope identifier may be, for example, a UE identifier (ueid), an identifier of a group of UEs (groupId), a network slice identifier (sliceId), a QoS identifier (qosId), a cell identifier (cellId). The scope identifier may be extended considering new features introduced, e.g., a network slice group identifier (slicegroupId).

The Near-RT RIC is a logical function that enables near-real-time control and optimization of RAN elements and resources via fine-grained (e.g. UE basis, network slice basis, Cell basis) data collection with measurements often provided at a faster rate than normally supported over network management interfaces and actions over E2 interface. The data collection may be extended considering new features, e.g., network slice groups. FIG. 4 also shows a near-real-time RIC, where E2 interface is provided between the near-real-time RIC and E2 nodes (gNB-DU, gNB-CU-UP, gNB-CU-CP). Upon receiving Policy on Al interface, the Near-RT RIC uses E2 interface to provide lower-level Imperative Policies to guide RAN optimization. When receiving A1 Policy with ueid as scope identifier, the near-RT RIC runs own algorithm and may send an E2 Imperative Policy for the UI identified by the given ueid to the RAN.

The E2 interface is defined in ORAN-WG3.E2GAP. E2 is a Control Plane interface and Imperative Policies can as well be sent over this interface to an “E2 Node”, i.e. any RAN node (gNB, gNB-CU, gNB-CU-CP, gNB-DU, eNB, etc.) that exposes an E2 interface. The general principles for the specification of the E2 interface include the following:
E2 supports the ability to provide information (including information concerning a specific end user equipment identified by a UE ID) towards the Near-RT RIC using a REPORT service based on a pre-established RIC Subscription.
E2 supports the ability to send control messages (e.g. UE basis, Cell basis) to the E2 Node.
E2 supports the ability to provide the E2 Node with a set of policies to use when defined events occur.

A UE-specific E2 Policy could be provided, when the Non-RT RIC sends a UE-specific Policy (with UE-ID) over A1 interface to a Near-RT RIC, which directly terminates either in a gNB or in said Near-RT RIC. In the latter case, upon receiving a UE specific-A1 Policy, the Near-RT RIC issues a E2 Policy for the given UE.

Another option for providing a UE specific-E2 Policy may take place such that a Near-RT RIC generates a UE-specific E2 Policy without any dependence over non-RT RIC. FIG. 6 shows an example of ORAN Near-RT RIC architecture. The Near-RT RIC comprises a database, which allows reading and writing of RAN and UE information, such as the configurations relating to E2 nodes, cells, bearers, flows, UEs and the mappings between them. The Near-RT RIC hosts one or more xApps that use E2 interface to collect near real-time information (e.g. UE basis, Cell basis) and provide value-added services. The Near-RT RIC further comprises xApp subscription management, which merges subscriptions from different xApps and provides unified data distribution to xApps. The conflict mitigation function resolves potentially overlapping or conflicting requests from multiple xApps. Moreover, the messaging infrastructure enables message interaction amongst Near-RT RIC internal functions.

When generating UE-specific E2 Policies independently, the Near-RT RIC provides value-added services to E2 Nodes over E2 interface. The value-added services are supported for the negotiated services exposed by an E2 Node. In case of a failure (of E2 interface or Near-RT RIC), the E2 Node shall be able to operate as usual with caveat that value-added services may experience outage.

It is that noted the Near-RT may alternatively support per-UE handling using a RIC Control message. One possible RIC Control message based E2 service is to assign the given UE to a pre-established Explicit UE List that is used as a policy condition within a pre-established E2 Policy.

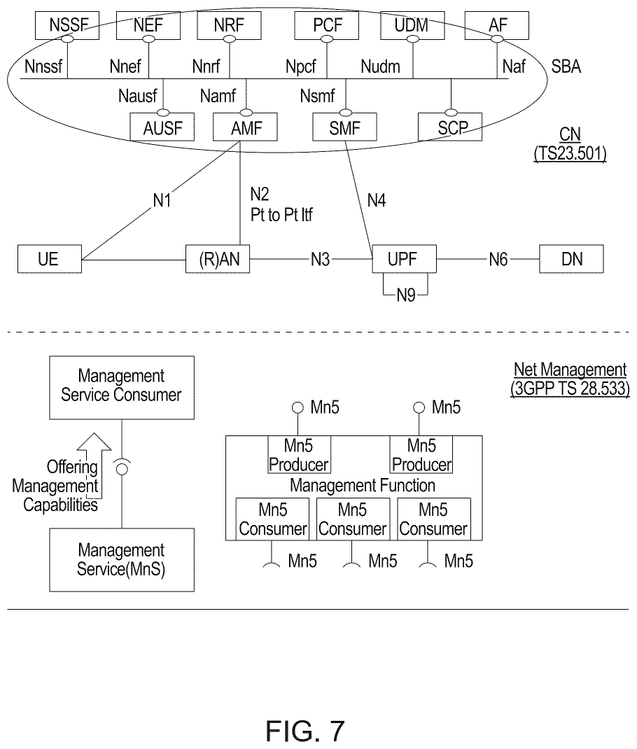

As discussed above, the mobile and wireless communications networks are increasingly deployed in cloud environments. Furthermore, the 5G and the following generations are aimed to be flexible by adding new functionalities into the system capitalizing on the cloud implementations. To this end, the 5G core network (5GC) is defined as service-based (SB) architecture (SBA) according to 3GPP TS 23.501, as shown in FIG. 7. The network management also employs SBA principles, referred to as service-based management architecture (SBMA), defined in 3GPP TS 28.533.

However, Access Networks (AN), e.g., Radio AN (RAN), and the associated interfaces, e.g., within AN and between AN and Core Network (CN) are defined as legacy P2P interfaces since the very early generations of PLMN. For example, in the 5G System (5GS), N2 is designed as a 3GPP NG-C Application Protocol over SCTP, between the gNB (or ng-eNB) and the AMF (Access and Mobility management Function). Further P2P interface examples within AN are the Xn interface between two gNBs, the F1 interface between a central unit (CU) and a distributed unit (DU) in case of a disaggregated gNB and the E1 interface between the CU-CP and the CU-UP in case of a disaggregated CU.

In the context of the O-RAN architecture comprising the entities of Non-RT RIC and Near-RT RIC, the Near-RT-RIC functionality includes among other things, optimization of UE services/QoS/etc. This is made possible by accumulation of data and building AI-ML based intelligence, which relies on, inter alia, averaged per-UE performance monitoring metrics. monitoring UE services/DRBs, KPIs defined by operator and computed in OAM, and UE traces.

However, when a UE undergoes mobility such that the source and the target RAN nodes are served by different near-RT-RICs, this UE-specific generated information stored in the near-RT RIC is lost. This is particularly critical when both the source and target Near-RT RIC have the same A1 Policy concerning the UE. In case of O-RAN, there is no mechanism to secure the per-UE intelligence information between RICs, e.g., in case of cell change between cells served by different gNB connected to different Near-RT RIC resulting in a change of serving near-RT RIC and geographically distributed RICs.

Moreover, upon change of serving Near-RT RIC, the per-UE information is not available at the target Near-RT RIC. For example, the Near-RT RIC may provide E2 Node, such as gNB-CU-CP, with a UE-specific Policy. Then, based on UE measurement reports, the source RAN node decides to move the UE to target RAN node. At this point, only the CU-CP of the NG-RAN node is aware if said UE is indeed impacted, since the RIC may not typically be aware of individual UEs impacted by any Policy. Consequently, when the UE is moved under target RAN node, which is served by a different Near-RT RIC, the UE information held in the previous Near-RT RIC is completely lost and has to be re-generated by the new Near-RT RIC using data collected by the new Near-RT RIC. The historical information on the UE held in the previous Near-RT RIC is lost.

In the following, an enhanced method for utilising the user equipment-specific information among near-RT RICs will be described in more detail, in accordance with various embodiments.

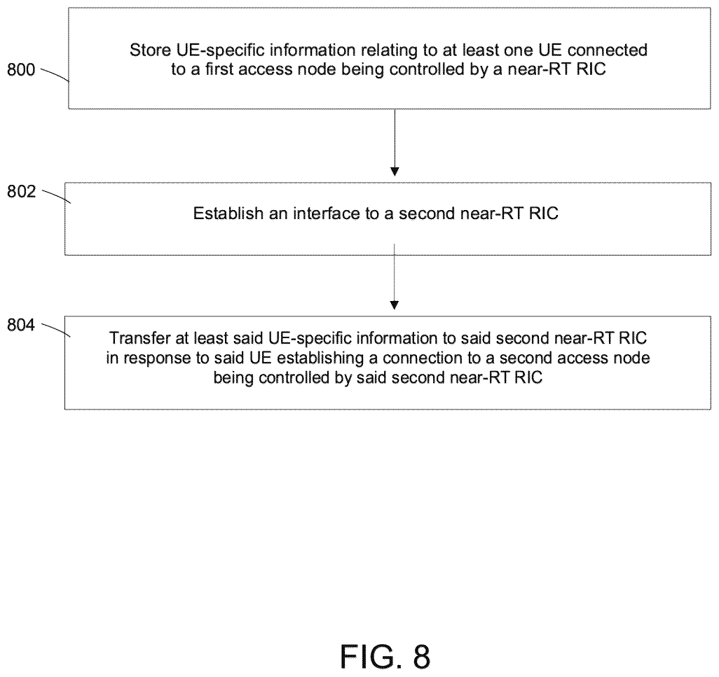

The method is disclosed in flow chart of FIG. 8 as reflecting the operation of an apparatus, such as a near-real-time radio access network intelligent controller (near-RT RIC), wherein the method comprises storing (800) user equipment-specific information relating to at least one user equipment connected to a first access node being controlled by said near-real-time radio access network intelligent controller; establishing (802) an interface to a second near-real-time radio access network intelligent controller; and transferring (804) at least said user equipment-specific information to said second near-real-time radio access network intelligent controller in response to said user equipment establishing a connection to a second access node being controlled by said second near-real-time radio access network intelligent controller.

Thus, by establishing a new type of interface between the near-RT RICs, the interface being referred to as E3 interface, the UE-specific information generated and stored by the first near-RT RIC can be transferred to the second near-RT RIC when the underlying UE establishes a connection with an access node, such as a RAN, under the control of the second near-RT RIC. The loss of the already processed UE information is prevented and accordingly, the second near-RT RIC does not have to start to re-generate the same information.

It is noted that user equipment-specific information may relate to a plurality of user equipment, such as a group of UEs.

According to an embodiment, the interface is a logical association implemented on one or more existing interfaces between the near-real-time radio access network intelligent controllers.

Hence, the new interface, referred to herein as E3 interface, may be considered a logical connection between the near-RT RICs, where one or more existing interfaces between the near-RT RICs are used as transport media for the logical E3 interface.

According to an embodiment, said existing interfaces comprise an E2 interface between a near-real-time radio access network intelligent controller and a corresponding access node and a X2/Xn interface between said access nodes.

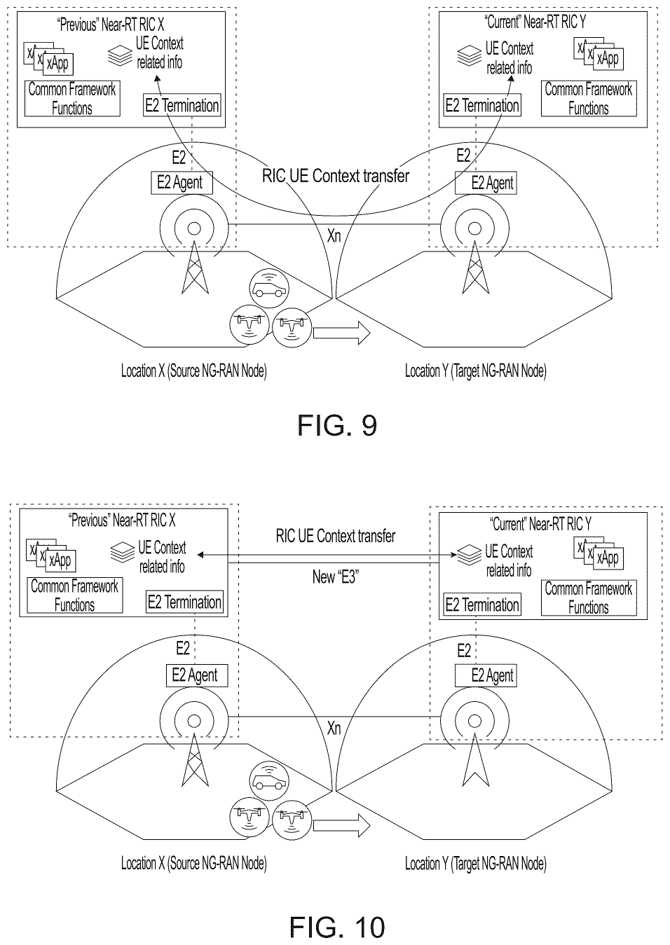

One possibility to the implement the E3 interface is to use the E2 interfaces between a near-RT RIC and an access node, such as a RAN node, e.g. gNB, under its control, and the Xn interface between gNB-CU-CPs as the transport media, as shown in FIG. 9. This is especially applicable, when the Near-RT RIC function is deployed as an aggregated node combining Near-RT RIC and gNB-CU-CP. Herein, the two interfaces may be either logically independent (i.e. sharing the same SCTP connection but with different logical interfaces) or the E3 interface may be carried as transparent data over Xn interface. The issues relating to xApp subscription management, such as providing unified data distribution of subscription to xApps and resolving conflicting requests from multiple xApps, are assumed to be implementation-specific at the source and target Near-RT RICs. It is noted that a similar solution may be used, when the Near-RT RIC and eNB are deployed as an aggregated node and the X2 interface between the eNBs is used to carry E3 information transfers.

According to an embodiment, the interface is implemented as direct message exchange between the near-real-time radio access network intelligent controllers.

Hence, it is also possible to establish any type of direct communication connection between the near-RT RICs, and use said connection as the transport media for the E3 interface message exchange, as shown in FIG. 10. The RIC UE context related information is provided in messages over the E3 interface between Near-RT RICs. Again, the correspondence of xAPPs at the source and target Near-RT RICs is assumed to be an implementation-specific.

According to an embodiment, said existing interfaces comprise a service-based architecture message bus.

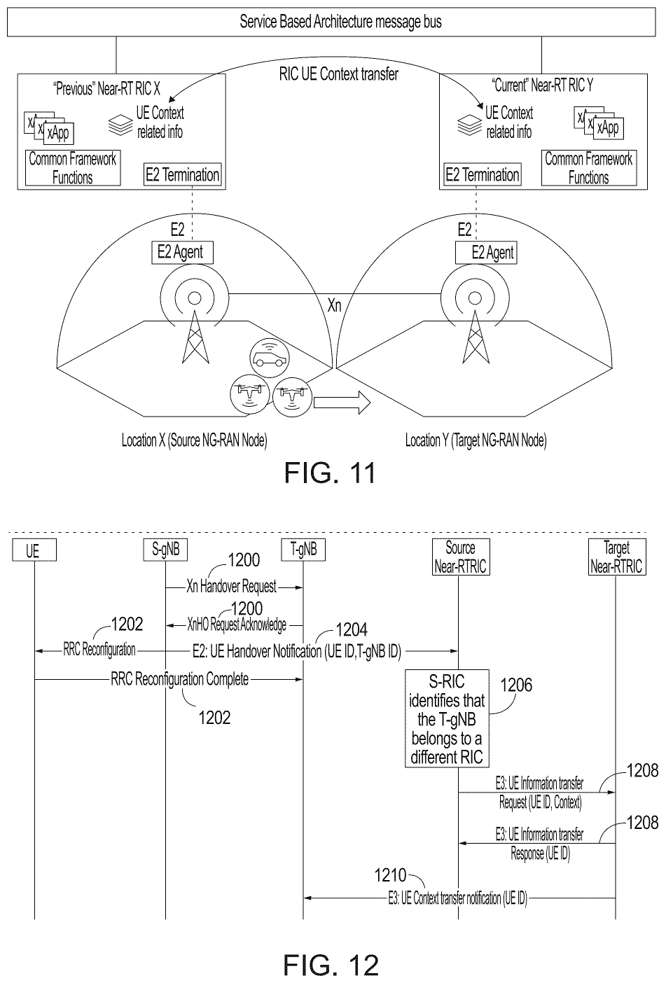

As described, due to the P2P-defined interfaces at the access network side, similar problems as described above are encountered, if the service-based architecture (SBA) principles are to be applied in access networks, such as in RANs. Thus, when the Near-RT RIC uses the SBA, the information transfer may be realised using a new “inter-Near-RT RIC information transfer service”, which is delivered via a SBA message bus, as shown in FIG. 11. The request for the service in placed on the SBA message bus, and the request is server by a service provider responsible for the service (not necessarily known by the UE or its user). The SBA message bus may also be implemented using the existing interfaces or the direct message approach, as described above, as the transport media for the bus.

According to an embodiment, the apparatus comprises means for triggering the transfer of at least said user equipment-specific information in response to detecting an event relating to a handover or dual connectivity of said at least one user equipment.

Hence, the transfer of the UE-specific information between the near-RT RICs is started when the UE establishes a connection with a target RAN node under the control of the second (target) near-RT RIC. This may relate to a handover from a source RAN node under the control of the first (source) near-RT RIC to target RAN node under the control of the second (target) near-RT RIC. This may also relate to a dual-connectivity situation, where the UE maintains its connection to the source RAN node under the control of the first (source) near-RT RIC, but also establishes a second connection to the target RAN node under the control of the second (target) near-RT RIC.

Dual Connectivity (DC) is a feature supported in LTE and in 5G NR enabling aggregation of two radio links at the PDCP (Packet Data Convergence Protocol) layer level. For resource aggregation, a UE in RRC_CONNECTED state is allocated two radio links from two different network nodes that may be connected via a non-ideal backhaul. The first node, Master Node (MN), serves as mobility and signaling anchor and the second node, Secondary Node (SN), provides additional local radio resources for UE. The two resource sets are called as Master Cell Group (MCG, associated with MN) and Secondary Cell Group (SCG, associated with SN). The MN can be either LTE eNB or NR gNB. The SN can be either LTE eNB or NR gNB. The MN and the SN can be the same node.

Dual Connectivity can improve user throughput and mobility robustness, since the users may be connected simultaneously to MCG and SCG, as well as improve load balancing between MCG and SCG resources.

It is noted that the term “establishing a connection”, as used above, may be determined, e.g., once a handover (HO) or a dual connectivity (DC) acknowledgement message is received or once a HO successful message (e.g., HO complete acknowledgement message) is received.

According to an embodiment, an indication about detecting the event relating to the handover or dual connectivity of said at least one user equipment is received from the second near-real-time radio access network intelligent controller.

Thus, the event relating to the handover or dual connectivity of the UE may be detected at the target RAN node, which informs the second (target) near-RT RIC. The second (target) near-RT RIC may then use a E3 interface message exchange to inform the first (source) near-RT RIC about the connection establishing of the UE, which then initiates the E3 interface transfer of the UE-specific information from the first (source) near-RT RIC to the second (target) near-RT RIC.

It is noted that the event relating to the handover or dual connectivity of the UE may as well be detected by the first (source) RAN node, which may then initiate the E3 interface transfer of the UE-specific information from the first (source) near-RT RIC to the second (target) near-RT RIC.

According to an embodiment, the apparatus comprises means for transferring access node-specific information about said first access node to said second near-real-time radio access network intelligent controller.

Hence, the E3 interface transfer may, in addition to the UE-specific information, also involve access node-specific information about the first (source) RAN node, which is transferred from the first (source) near-RT RIC to the second (target) near-RT RIC. The near-RT RICs may share information on, for example, RAN nodes that are located in the coverage boundary zones between the near-RT RICs.

According to an embodiment, the apparatus comprises means for transferring user equipment-specific policy information obtained from a corresponding non-real-time radio access network intelligent controller to said second near-real-time radio access network intelligent controller.

Hence, the E3 interface transfer may, in addition to the UE-specific information, also involve user equipment-specific policy information, which is obtained from non-RT RIC associated with the first (source) near-RT RIC. Such information transfer may be performed either on a periodic and/or an on-demand basis, and it may involve, for xample, A1 Policy information and A1 Enrichment Information (EI) transfer. This allows the neighbouring Near-RT RICs to exchange current A1 Policy information, for example, concerning cells in boundary zones. The information transfer may be triggered on an event driven basis. It is noted that such information transfer may not be required, if the non-RT RIC sends similar A1 Policy and A1 EI (Enrichment Information) to both near-RT RICs, i.e. to the first (source) near-RT RIC and the second (target) near-RT RIC.

According to an embodiment, said at least one user equipment is identified by a unique identifier, such as a pair of AMF UE NGAP ID identifier and GUAMI (Globally Unique AMI) identifier.

An AMF UE NGAP ID is used 5G/NR to uniquely identify the UE over the NG interface within the AMF. GUAMI (Globally Unique AMI) is used to uniquely identify an AMF within a 5G network. It comprises the MCC (Mobile Country Code), MNC (Mobile Network Code), AMF Region ID, AMF Set ID and AMF Pointer.

According to an embodiment, the apparatus comprises means for transferring information concerning a list of connected access nodes, such as e/gNBs, and served cells over said interface to the second near-real-time radio access network intelligent controller.

Thus, for example a list of connected E2 nodes may be provided over the E3 interface.

According to an embodiment, the apparatus comprises means for transferring information concerning the connected access nodes, such as e/gNBs, and served cells over said interface to the second near-real-time radio access network intelligent controller.

Hence, the E3 interface may be used to provide more specific details about one or more of the listed E2 nodes.

According to an embodiment, the apparatus comprises means for transferring information derived by the apparatus using information obtained from connected access nodes, such as e/gNBs, over said interface to the second near-real-time radio access network intelligent controller.

Such information, derived by the near-RT RIC, may comprise, for example, machine learning (ML) and/or artificial intelligence (AI)-based information about the status of one or more of the connected access nodes. The near-RT RIC may also obtain at least part of the information from the non-RT RIC, which in its SMO domain may provide, for example, ML model management for the near-RT RIC.

There are two alternative solutions to perform the transfer of the UE-specific information between RICs:
A push method where the trigger for the information transfer is detected and delivered by the source near-RT RIC after handover/dual connectivity preparations over Xn. Here, the source gNB can provide the trigger for the information transfer to the source near-RT RIC.
A pull method where the trigger for the information transfer is detected and delivered by the target near-RT RIC after handover/dual connectivity execution by the UE. Here, the target gNB can provide the trigger for the information transfer to the target near-RT RIC.

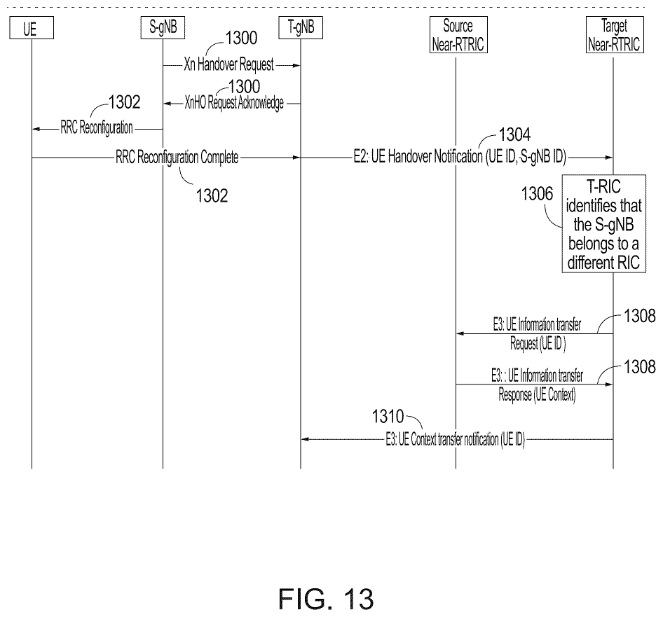

The signalling chart of FIG. 12 illustrates an example of the push method. E2 node (e.g. a source gNB) performs an Xn based handover of a UE to the neighboring E2 node (target gNB), said handover process including the Xn handover request/acknowledge process (1200) and the RRC Reconfiguration process with the UE (1202). The source E2 node informs (1204) the first (source) near-RT RIC about the HO indicating the UE ID and the target gNB ID. The first (source) near-RT RIC determines (1206) that the target gNB ID is under the coverage of a different, i.e. second (target) near-RT RIC. The first (source) near-RT RIC executes an E3 transfer push procedure of the UE Context (1208) to transfer the per-UE information from the first (source) near-RT RIC to the second (target) near-RT RIC. If required, the second (target) near-RT RIC may pass (1210) the UE context information to target E2 Node (target gNB) or may issue an E2 Policy message using the information that has been received from the first (source) near-RT RIC.

The signalling chart of FIG. 13 illustrates an example of the pull method. Again, E2 node (e.g. a source gNB) performs an Xn based handover of a UE to the neighboring E2 node (target gNB), said handover process including the Xn handover request/acknowledge process (1300) and the RRC Reconfiguration process with the UE (1302). The target E2 node notifies (1304) its corresponding near-RT RIC, i.e. second (target) near-RT RIC, about the arrival of the UE by providing the UE ID and the source gNB ID. The second (target) near-RT RIC determines (1306) that the source gNB ID is under the coverage of a different, i.e. first (source) near-RT RIC. The second (target) near-RT RIC executes an E3 transfer pull procedure of the UE Context (1308) to transfer the per-UE information from the first (source) near-RT RIC to the second (target) near-RT RIC. If required, the second (target) near-RT RIC may pass (1310) the UE context information to target E2 Node (target gNB).

The method and the embodiments related thereto may also be implemented in an apparatus implementing functionalities of a near-real-time radio access network intelligent controller. An apparatus according to an aspect comprises means for implementing a near-real-time radio access network intelligent controller; means for storing user equipment-specific information relating to at least one user equipment connected to a first access node being controlled by said near-real-time radio access network intelligent controller; means for establishing an interface to a second near-real-time radio access network intelligent controller; and means for transferring at least said user equipment-specific information to said second near-real-time radio access network intelligent controller in response to said user equipment establishing a connection to a second access node being controlled by said second near-real-time radio access network intelligent controller.

The means as referred to herein and in related embodiments may comprise at least one processor; and at least one memory including computer program code, the at least one memory and computer program code configured to, with the at least one processor, cause the performance of the apparatus.

An apparatus implementing functionalities of a near-real-time radio access network intelligent controller according to a further aspect comprises at least one processor and at least one memory, said at least one memory stored with computer program code thereon, the at least one memory and the computer program code configured to, with the at least one processor, cause the apparatus at least to perform: store user equipment-specific information relating to at least one user equipment connected to a first access node being controlled by said near-real-time radio access network intelligent controller; establish an interface to a second near-real-time radio access network intelligent controller; and transfer at least said user equipment-specific information to said second near-real-time radio access network intelligent controller in response to said user equipment establishing a connection to a second access node being controlled by said second near-real-time radio access network intelligent controller.

According to an embodiment, the apparatus comprises code causing the apparatus to trigger the transfer of at least said user equipment-specific information in response to detecting an event relating to a handover or dual connectivity of said at least one user equipment.

According to an embodiment, the apparatus comprises code causing the apparatus to transfer access node-specific information about said first access node to said second near-real-time radio access network intelligent controller.

According to an embodiment, the apparatus comprises code causing the apparatus to transfer user equipment-specific policy information obtained from a corresponding non-real-time radio access network intelligent controller to said second near-real-time radio access network intelligent controller.

According to an embodiment, the apparatus comprises code causing the apparatus to transfer information concerning a list of connected access nodes, such as e/gNBs, and served cells over said interface to the second near-real-time radio access network intelligent controller.

According to an embodiment, the apparatus comprises code causing the apparatus to transfer information concerning the connected access nodes, such as e/gNBs, and served cells over said interface to the second near-real-time radio access network intelligent controller.

According to an embodiment, the apparatus comprises code causing the apparatus to transfer information derived by the apparatus using information obtained from connected access nodes, such as e/gNBs, over said interface to the second near-real-time radio access network intelligent controller.

Such apparatuses may comprise e.g. the functional units disclosed in any of the FIGS. 1-4 for implementing the embodiments.

A further aspect relates to a computer program product, stored on a non-transitory memory medium, comprising computer program code, which when executed by at least one processor, causes an apparatus at least to perform: store user equipment-specific information relating to at least one user equipment connected to a first access node being controlled by said near-real-time radio access network intelligent controller; establish an interface to a second near-real-time radio access network intelligent controller; and transfer at least said user equipment-specific information to said second near-real-time radio access network intelligent controller in response to said user equipment establishing a connection to a second access node being controlled by said second near-real-time radio access network intelligent controller.

In general, the various embodiments of the invention may be implemented in hardware or special purpose circuits or any combination thereof. While various aspects of the invention may be illustrated and described as block diagrams or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

Embodiments of the inventions may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

Programs, such as those provided by Synopsys, Inc. of Mountain View, California and Cadence Design, of San Jose, California automatically route conductors and locate components on a semiconductor chip using well established rules of design as well as libraries of pre stored design modules. Once the design for a semiconductor circuit has been completed, the resultant design, in a standardized electronic format (e.g., Opus, GDSII, or the like) may be transmitted to a semiconductor fabrication facility or “fab” for fabrication.

The foregoing description has provided by way of exemplary and non-limiting examples a full and informative description of the exemplary embodiment of this invention. However, various modifications and adaptations may become apparent to those skilled in the relevant arts in view of the foregoing description, when read in conjunction with the accompanying drawings and the appended examples. However, all such and similar modifications of the teachings of this invention will still fall within the scope of this invention.

1. An apparatus comprising:
means for implementing a near-real-time radio access network intelligent controller;
means for storing user equipment-specific information relating to at least one user equipment connected to a first access node being controlled by said near-real-time radio access network intelligent controller;
means for establishing an interface to a second near-real-time radio access network intelligent controller; and
means for transferring at least said user equipment-specific information to said second near-real-time radio access network intelligent controller in response to said user equipment establishing a connection to a second access node being controlled by said second near-real-time radio access network intelligent controller.

2. The apparatus according to claim 1, wherein the interface is a logical association implemented on one or more existing interfaces between the near-real-time radio access network intelligent controllers.

3. The apparatus according to claim 2, wherein said existing interfaces comprise an E2 interface between a near-real-time radio access network intelligent controller and a corresponding access node and a X2/Xn interface between said access nodes.

4. The apparatus according to claim 1, wherein the interface is implemented as direct message exchange between the near-real-time radio access network intelligent controllers.

5. The apparatus according to any preceding claim, wherein said existing interfaces comprise a service-based architecture message bus.

6. The apparatus according to any preceding claim, comprising
means for triggering the transfer of at least said user equipment-specific information in response to detecting an event relating to a handover or dual connectivity of said at least one user equipment.

7. The apparatus according to claim 6, wherein an indication about detecting the event relating to the handover or dual connectivity of said at least one user equipment is received from the second near-real-time radio access network intelligent controller.

8. The apparatus according to any preceding claim, comprising
means for transferring access node-specific information about said first access node to said second near-real-time radio access network intelligent controller.

9. The apparatus according to any preceding claim, comprising
means for transferring user equipment-specific policy information obtained from a corresponding non-real-time radio access network intelligent controller to said second near-real-time radio access network intelligent controller.

10. The apparatus according to any preceding claim, wherein said at least one user equipment is identified by a unique identifier, such as a pair of AMF UE NGAP ID identifier and GUAMI (Globally Unique AMI) identifier.

11. The apparatus according to any preceding claim, comprising
means for transferring information concerning a list of connected access nodes and served cells over said interface to the second near-real-time radio access network intelligent controller.

12. The apparatus according to any preceding claim, comprising
means for transferring information concerning the connected access nodes and served cells over said interface to the second near-real-time radio access network intelligent controller.

13. The apparatus according to any preceding claim, comprising
means for transferring information derived by the apparatus using information obtained from connected access nodes over said interface to the second near-real-time radio access network intelligent controller.

14. The apparatus of any preceding claim wherein the means comprises at least one processor; and at least one memory including computer program code, the at least one memory and computer program code configured to, with the at least one processor, cause the performance of the apparatus.

15. A method comprising:
storing, by an apparatus comprising functionalities of a near-real-time radio access network intelligent controller, user equipment-specific information relating to at least one user equipment connected to a first access node being controlled by said near-real-time radio access network intelligent controller;
establishing an interface to a second near-real-time radio access network intelligent controller; and
transferring at least said user equipment-specific information to said second near-real-time radio access network intelligent controller in response to said user equipment establishing a connection to a second access node being controlled by said second near-real-time radio access network intelligent controller.

16. The method according to claim 15, wherein the interface is a logical association implemented on one or more existing interfaces between the near-real-time radio access network intelligent controllers.

17. The method according to claim 15, wherein said existing interfaces comprise an E2 interface between a near-real-time radio access network intelligent controller and a corresponding access node and a X2/Xn interface between said access nodes.

18. The method according to claim 15, wherein the interface is implemented as direct message exchange between the near-real-time radio access network intelligent controllers.

19. The method according to any of the preceding claims 15-18, wherein said existing interfaces comprise a service-based architecture message bus.

20. The method according to any of the preceding claims 15-19, comprising
triggering the transfer of at least said user equipment-specific information in response to detecting an event relating to a handover or dual connectivity of said at least one user equipment.

21. The method according to claim 20, wherein an indication about detecting the event relating to the handover or dual connectivity of said at least one user equipment is received from the second near-real-time radio access network intelligent controller.

22. The method according to any of the preceding claims 15-21, comprising
transferring access node-specific information about said first access node to said second near-real-time radio access network intelligent controller.

23. The method according to any of the preceding claims 15-22, comprising transferring user equipment-specific policy information obtained from a corresponding non-real-time radio access network intelligent controller to said second near-real-time radio access network intelligent controller.

24. The method according to any of the preceding claims 15-23, wherein said at least one user equipment is identified by a unique identifier, such as a pair of AMF UE NGAP ID identifier and GUAMI (Globally Unique AMI) identifier.

25. The method according to any of the preceding claims 15-24, comprising
transferring information concerning a list of connected access nodes and served cells over said interface to the second near-real-time radio access network intelligent controller.

26. The method according to any of the preceding claims 15-25, comprising
transferring information concerning the connected access nodes and served cells over said interface to the second near-real-time radio access network intelligent controller.

27. The method according to any of the preceding claims 15-26, comprising
transferring information derived by the apparatus using information obtained from connected access nodes over said interface to the second near-real-time radio access network intelligent controller.

28. An apparatus comprising at least one processor and at least one memory, said at least one memory stored with computer program code thereon, the at least one memory and the computer program code configured to, with the at least one processor, cause the apparatus at least to perform:
implement functionalities of a near-real-time radio access network intelligent controller;
store user equipment-specific information relating to at least one user equipment connected to a first access node being controlled by said near-real-time radio access network intelligent controller;
establish an interface to a second near-real-time radio access network intelligent controller; and
transfer at least said user equipment-specific information to said second near-real-time radio access network intelligent controller in response to said user equipment establishing a connection to a second access node being controlled by said second near-real-time radio access network intelligent controller.

29. A computer program product, stored on a non-transitory memory medium, comprising computer program code, which when executed by at least one processor, causes an apparatus at least to perform:
store user equipment-specific information relating to at least one user equipment connected to a first access node being controlled by said near-real-time radio access network intelligent controller;
establish an interface to a second near-real-time radio access network intelligent controller; and
transfer at least said user equipment-specific information to said second near-real-time radio access network intelligent controller in response to said user equipment establishing a connection to a second access node being controlled by said second near-real-time radio access network intelligent controller.
